(19) United States
(12) Patent Application Publication
(10) Pub. No.: US 2010/0311453 A1
(43) Pub. Date: Dec. 9, 2010

(54) DEVICE, SYSTEM AND METHOD OF INTERFACING BETWEEN A BASEBAND (BB) MODULE AND A RADIO-FREQUENCY (RF) MODULE OF A WIRELESS COMMUNICATION DEVICE

(76) Inventors: Yoav Nissan-Cohen, Tel Aviv (IL); Shlomo Arbel, Shoham (IL)

Correspondence Address: EITAN MEHULAL LAW GROUP, 10 Abba Eban Blvd. PO Box 2081, Herzlia, 46120, IL

(21) Appl. No.: 12/735,396

(22) PCT Filed: Jan. 15, 2009
(86) PCT No.: PCT/IL2009/000064

§ 371 Date: Jul. 13, 2010

Related U.S. Application Data
(60) Provisional application No. 61/006,523, filed on Jan. 17, 2008.
(60) Provisional application No. 61/064,402, filed on Mar. 4, 2008.

(51) Int. Cl. H04B 7/00

(52) U.S. Cl. 455/509

(57) ABSTRACT

Some demonstrative embodiments include interfacing between BB and RF modules of a wireless communication device. In some embodiments the RF module includes at least one transmit antenna; a plurality of receive antennas; at least one uplink input connectable to the BB module to receive from the BB module uplink signals to be transmitted via the at least one transmit antenna; a plurality of downlink outputs connectable to the BB module to provide the BB module with downlink signals corresponding to wireless signals received via the plurality of receive antennas; and a control interface connectable to the BB module to receive from the BB module a filter-calibration control signal. The RF module may output via one or more of the plurality of downlink outputs one or more respective filtered calibration signals corresponding to a filter calibration signal received via the uplink input. Other embodiments are described and claimed.

### CROSS-REFERENCE

This application claims the benefit of U.S. Provisional Patent application 61/006,523, entitled “Device, system, and method of interfacing between baseband and radio-frequency of a wireless communication device”, filed Jan. 17, 2008, and of U.S. Provisional Patent application 61/064,402, entitled “Device, system, and method of interfacing between baseband and radio-frequency of a wireless communication device”, filed Mar. 4, 2008, the entire disclosures of both of which are incorporated herein by reference.

### FIELD

Some embodiments relate generally to the filed of wireless communication and, more particularly, to interfacing between Radio-Frequency (RF) and Base-Band (BB) modules.

### BACKGROUND

Wireless communication has rapidly evolved over the past decades. Even today, when high performance and high bandwidth wireless communication equipment is made available there is demand for even higher performance at a higher data rates, which may be required by more demanding applications.

Video signals may be generated by various video sources, for example, a computer, a game console, a Video Cassette Recorder (VCR), a Digital-Versatile-Disc (DVD), or any other suitable video source. In many houses, for example, video signals are received through cable or satellite links at a Set-Top Box (STB) located at a fixed point.

In many cases, it may be desired to place a display, screen or projector at a location in a distance of at least a few meters from the video source. This trend is becoming more common as flat-screen displays, e.g., plasma or Liquid Crystal Display (LCD) televisions are hung on a wall. Connection of such a display or projector to the video source through cables is generally undesired for aesthetic reasons and/or installation convenience. Thus, wireless transmission of the video signals from the video source to the screen is preferred.

### SUMMARY

Some embodiments include, for example, devices, systems, and methods of interfacing between Radio-Frequency (RF) and Base-Band (BB) modules of a wireless communication module.

Some embodiments include a wireless communication device including a radio-frequency (RF) module connectable to a base-band (BB) module. The RF module may include at least one transmit antenna; a plurality of receive antennas; at least one uplink input connectable to the BB module to receive from the BB module uplink signals to be transmitted via the at least one transmit antenna; a plurality of downlink outputs connectable to the BB module to provide the BB module with downlink signals corresponding to wireless signals received via the plurality of receive antennas; and a control interface connectable to the BB module to receive from the BB module a filter-calibration control signal. Responsive to the filter-calibration control signal, the RF module is to output via one or more of the plurality of downlink outputs one or more respective filtered calibration signals corresponding to a filter calibration signal received via the uplink input.

In some embodiments, the RF module includes a plurality of receive filters to filter the wireless signals received via the plurality of receive antennas; a splitter having a plurality of outputs connected to inputs of the plurality of receive filters, respectively; a switch having a closed mode, in which the uplink input is connected to an input of the splitter, and an open mode, in which the uplink input is disconnected from the input of the splitter; and a controller to receive the control signal via the control interface and, responsive to the control signal, to cause the switch to switch to the closed mode.

In some embodiments, the controller is to receive from the BB module a calibration instruction via the control interface, and to calibrate one or more of the receive filters based on the calibration instruction.

In some embodiments, the RF module includes an oscillator; and a controller to receive from the BB module an oscillator calibration signal via the control interface and, responsive to the oscillator calibration signal, to calibrate an oscillation frequency of the oscillator.

In some embodiments, the RF module includes a received-signal-strength-indicator (RSSI) output connectable to the BB module. Responsive to a RSSI control signal received via the control interface, the RF module is to output via the RSSI output at least one RSSI signal corresponding to wireless signals received via at least one of the plurality of receive antennas, respectively.

In some embodiments, the RSSI control signal indicates a selected receive antenna of the plurality of receive antennas. The outputted RSSI signal corresponds to wireless signals received via the selected receive antenna.

In some embodiments, the plurality of downlink outputs include a plurality of sets of at least two downlink outputs, wherein each set of downlink outputs is to provide the BB module with downlink signals corresponding to wireless signals received via a respective one of the plurality of receive antennas.

In some embodiments, the filter calibration signal and the plurality of filtered calibration signals include analog signals, and wherein the filter calibration control signal includes a digital signal.

In some embodiments, the control interface includes a serial-peripheral-interface bus.

In some embodiments, responsive to the filter-calibration control signal, the RF module is to output via the plurality of downlink outputs a respective plurality of filtered calibration signals corresponding to the filter calibration signal.

Some embodiments include a wireless communication device including a RF module connectable to a BB module, wherein the RF module includes at least one receive antenna; a plurality of transmit antennas; a plurality of downlink inputs connectable to the BB module to receive from the BB module downlink signals to be transmitted via the plurality of transmit antennas; at least one uplink output connectable to the BB module to provide the BB module with uplink signals corresponding to wireless signals received via the at least one receive antenna; and a control interface connectable to the BB module to receive from the BB module a filter-calibration control signal. Responsive to the filter-calibration control signal and to at least one filter calibration signal received via at least one of the plurality of downlink inputs, respectively, the RF module is to output via the uplink output at least one filtered calibration signal corresponding to the at least one filter calibration signal, respectively.

In some embodiments, the RF module includes a plurality of transmit filters to filter the wireless signals received via the plurality of downlink inputs; a multiplexer having a plurality of inputs connected to outputs of the plurality of transmit filters, respectively, and at least one output to selectively output, based on a selection signal, at least one filtered calibration signal received via at least one selected input of the plurality of inputs; at least one switch having a closed mode, in which the at least one output of the multiplexer is connected to the at least one uplink output, respectively, and an open mode, in which the at least one output of the multiplexer) is disconnected from the at least one uplink output, respectively; and a controller to receive the filter-calibration control signal via the control interface and, responsive to the filter-calibration control signal, to cause the switch to switch to the closed mode, and to provide the multiplexer with the selection signal.

In some embodiments, the controller is to receive from the BB module a calibration instruction via the control interface, and to calibrate one or more of the transmit filters based on the calibration instruction.

In some embodiments, the RF module includes an oscillator; and a controller to receive from the BB module an oscillator calibration signal via the control interface and, responsive to the oscillator calibration signal, to calibrate an oscillation frequency of the oscillator.

In some embodiments, the RF module is to receive a predefined control signal via the control interface; to receive at least one predefined calibration signal via at least one of the downlink inputs, respectively; and to output via the uplink output at least one power-detector signal corresponding to the predefined calibration signal.

In some embodiments, the RF module includes a plurality of power detectors located along a respective plurality of transit paths of the plurality of transmit antennas, respectively, wherein the plurality of power detectors are to generate a plurality of power-detection signals, respectively, responsive to a plurality of calibration signals received via the plurality of downlink inputs, respectively; a multiplexer having a plurality of inputs connected to outputs of the plurality of power detectors, respectively, to selectively output, based on a selection signal, a selected power detector signal received via a selected input of the plurality of inputs; a switch having a closed mode, in which the output of the multiplexer is connected to the uplink output, and an open mode, in which the output of the multiplexer is disconnected from the uplink output; and a controller to receive the predefined control signal via the control interface and, responsive to the predefined control signal, to cause the switch to switch to the closed mode and to provide the selection signal to the multiplexer.

In some embodiments, the RF module includes a power-amplifier output connectable to the BB module, wherein the RF module is to receive via the control interface a predefined control signal form the BB module identifying a selected transmit path corresponding to a selected one of the transmit antennas, and wherein, in response to the control signal, the RF module is to output via the power-amplifier output a power-amplifier-detect signal corresponding to a power-amplification along the selected transmit path.

In some embodiments, the RF module includes a plurality of power amplifiers located along the plurality of transmit paths, respectively; a multiplexer having an output connected to the power-amplifier output and a plurality of inputs to receive a plurality of power-amplifier-detect signals from the plurality of power amplifiers, respectively; and a controller to receive the predefined control signal via the control interface and, responsive to the predefined control signal, to cause the multiplexer to output the power-amplifier-detect signal of the selected transmit path.

In some embodiments, the multiplexer includes a RSSI input to receive a RSSI signal corresponding to the wireless signals received via the receive antenna. Responsive to a RSSI control signal received via the control interface, the controller is to cause the multiplexer to output the RSSI signal.

In some embodiments, the plurality of downlink inputs include a plurality of sets of at least two downlink inputs, wherein each set of downlink inputs is to receive from the BB module downlink signals to be transmitted via a respective one of the plurality of receive antennas.

In some embodiments, the filtered calibration signal and the plurality of filter calibration signals include analog signals, and wherein the filter-calibration control signal includes a digital signal.

In some embodiments, the control interface includes a serial-peripheral-interface bus.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system in accordance with some demonstrative embodiments.

FIG. 2 is a schematic illustration of a source Radio-Frequency (RF)-Base-Band (BB) interface scheme, in accordance with some demonstrative embodiments.

FIG. 3 is a schematic illustration of a destination RF-BB interface scheme, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein includes, for example, “multiple” or “two or more”. For example, “a plurality of items” includes two or more items.

Some embodiments may be used in conjunction with one or more types of wireless communication signals and/or systems, for example, Radio Frequency (RF), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Carrier Modulation (MDM), Discrete Multi-Tone (DMT), Bluetooth®, Global Positioning System (GPS), Wi-Fi, Wi-Max, ZigBee™, Global System for Mobile communication (GSM), 2G, 2.5G, 3G, 3.5G, or the like. Some embodiments may be used in various other devices, systems and/or networks.

Some embodiments are described herein with reference to OFDM communication. However, other embodiments may be implemented with respect to any other suitable modulation and/or wireless communication.

It should be understood that some embodiments may be used in a variety of applications. One or more of the methods, devices and/or systems disclosed herein may be used in many applications, e.g., civil applications, military applications or any other suitable application.

In some demonstrative embodiments the methods, devices and/or systems disclosed herein may be used in the field of consumer electronics, for example, as part of any suitable television, video Accessories, Digital-Versatile-Disc (DVD), multimedia projectors, Audio and/or Video (A/V) receivers/transmitters, gaming consoles, video cameras, video recorders, and/or automobile A/V accessories.

In some demonstrative embodiments the methods, devices and/or systems disclosed herein may be used in the field of Personal Computers (PC), for example, as part of any suitable desktop PC, notebook PC, monitor, and/or PC accessories. In some demonstrative embodiments the methods, devices and/or systems disclosed herein may be used in the field of professional A/V, for example, as part of any suitable camera, video camera, and/or A/V accessories.

In some demonstrative embodiments the methods, devices and/or systems disclosed herein may be used in the medical field, for example, as part of any suitable endoscopy device and/or system, medical video monitor, and/or medical accessories.

In some demonstrative embodiments the methods, devices and/or systems disclosed herein may be used in the field of security and/or surveillance, for example, as part of any suitable security camera, and/or surveillance equipment.

In some demonstrative embodiments the methods, devices and/or systems disclosed herein may be used in the fields of military, defense, digital signage, commercial displays, retail accessories, and/or any other suitable field or application.

One or more of the methods, devices and/or systems disclosed herein may be used to wirelessly transmit video signals, for example, High-Definition-Television (HDTV) signals, between at least one video source and at least one video destination. In other embodiments, the methods, devices and/or systems disclosed herein may be used to transmit, in addition to or instead of the video signals, any other suitable signals, for example, any suitable multimedia signals, e.g., audio signals, between any suitable multimedia source and/or destination.

Although some demonstrative embodiments are described herein with relation to wireless communication including video information, some embodiments may be implemented to perform wireless communication of any other suitable information or data. In one example, some embodiments may be implemented to perform wireless communication of multimedia information, e.g., audio information, in addition to or instead of the video information. Some embodiments may include, for example, a method, device and/or system of performing wireless communication of A/V information, e.g., including audio and/or video information. Accordingly, one or more of the devices, systems and/or methods described herein with relation to video information may be adapted to perform wireless communication of A/V information.

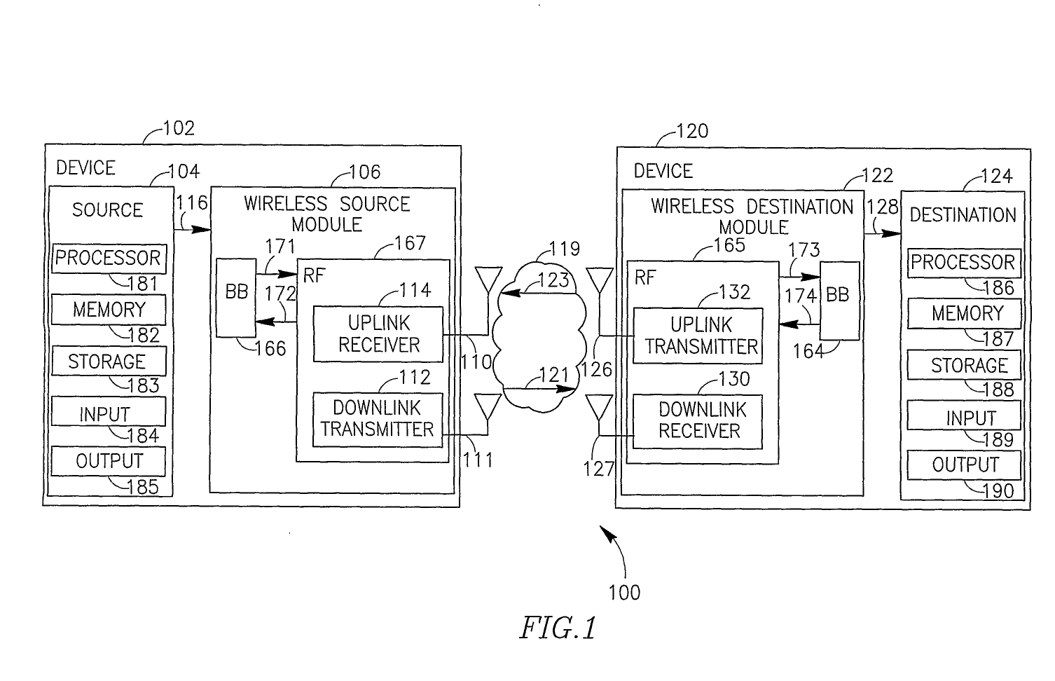

Reference is made to FIG. 1, which schematically illustrates a system 100, in accordance, with some demonstrative embodiments.

In some demonstrative embodiments, system 100 may include a wireless source module 106 capable of communicating with a wireless destination module 122 via a wireless communication channel 119, e.g., as described below.

In some demonstrative embodiments, wireless source module 106 may transmit to wireless destination module 122 a wireless downlink (DL) transmission 121 corresponding to data 116 received from a source module 102. For example, wireless source module 106 may transmit DL transmission 121 via one or more transmit (Tx) antennas 111, e.g., as described below.

In some demonstrative embodiments, wireless destination module 122 may receive wireless downlink transmission 121, for example, via one or more receive (Rx) antennas 127. Wireless destination module 122 may be capable of generating output data 128, which may correspond to data 116, based on downlink transmission 121, e.g., as described below.

In some demonstrative embodiments, system 100 may also include a destination module 124 to handle and/or process data 128. In one embodiment, destination module 124 may include any suitable video destination module, for example, any suitable display to display a video image based on data 128, e.g., as described below. In other embodiments, destination module 124 may include any other suitable module capable of processing and/or handling data 128.

In some demonstrative embodiments, wireless destination module 122 may also be capable of transmitting to wireless source module 106 a wireless uplink (UL) transmission 123, for example, via one or more Tx antennas 126. RF module 167 may be capable of receiving UL transmission 123 via one or more Rx antennas 110.

DL transmission 121 and uplink transmission 123 may include any suitable RF signals, blocks, frames, transmission streams, packets, video frames, control signals, messages and/or data, e.g., as described below.

In some embodiments, wireless source module 106 and/or wireless destination module 122 may include a Base-Band (BB) module interfacing a Radio-Frequency (RF) module. For example, wireless source module 106 may include a source BB module 166 interfacing a source RF module 167; and/or wireless destination module 122 may include a destination BB module 164 interfacing a destination RF module 165, e.g., as described in detail below.

In some embodiments, BB module 166 may implement any suitable BB processing method ad/or algorithm to generate signals 171 to be transmitted by RF module 167 as part of DL transmission 121, based on data 116. RF module 167 may generate signals 172 corresponding to UL transmission 123, and BB module 166 may process and/or handle signals 172 in any suitable manner, e.g., to control RF module 167 and/or to configure the generation of signals 171.

In some embodiments, RF module 165 may generate signals 173 corresponding to DL transmission 121, and BB module 166 may implement any suitable BB processing method and/or algorithm to generate data 128 based on signals 173. BB module 167 may generate signals 174 to be transmitted as part of UL transmission 123, e.g., to control RF module 167 and/or to configure the generation of signals 171. RF module 165 may transmit UL transmission 123 based on signals 174.

In some embodiments, RF module 167 may include at least one downlink transmitter path 112 to transmit downlink transmission 121 via antennas 111; and at least one uplink receiver path 114 to receive UL transmission 121 via antennas 110.

In some embodiments, RF module 165 may include at least one downlink receiver path 130 to transmit downlink transmission 121 via antennas 127; and at least one uplink transmitter path 132 to transmit UL transmission 123 via antennas 126.

In some demonstrative embodiments, wireless source module 106 and/or wireless destination module 122 may implement any suitable transmission method and/or configuration to transmit downlink transmission 121 and/or plink transmission 123, respectively. In one demonstrative embodiment, wireless source module 106 may generate downlink transmission 121 and/or wireless destination module 122 may generate uplink transmission 123 according to an Orthogonal-Division-Frequency-Multiplexing (OFDM) modulation scheme. According to other embodiments, wireless source module 106 may generate downlink transmission 121 and/or wireless destination module 122 may generate uplink transmission 123 according to any other suitable modulation and/or transmission scheme. In some demonstrative embodiments, wireless destination module 122 may receive and/or demodulate downlink transmission 121 and/or wireless source module 106 may receive and/or demodulate uplink transmission 123 according to the OFDM modulation scheme. According to other embodiments, wireless source module 106 and/or wireless destination module 122 may receive and/or demodulate transmissions 123 and/or 121, respectively, according to any other suitable modulation and/or transmission scheme.

In some demonstrative embodiments, downlink transmission 121 may include a Multiple-Input-Multiple-Output (MIMO) transmission. For example, BB module 166 may modulate the data of transmission 121 according to a suitable MIMO modulation scheme. In one embodiment, antennas 110 may include a plurality of Tx antennas, e.g., four Tx antennas, to transmit MIMO downlink transmission 121; and/or antennas 126 may include a plurality of Rx antennas, e.g., five Rx antennas, to receive MIMO downlink transmission 121. In other embodiments, antennas 110 and/or 126 may include any other suitable number of antennas.

In some embodiments, antennas 110, 111, 126 and/or 127 may include an internal and/or external RF antenna, a dipole antenna, a monopole antenna, an omni-directional antenna, an end fed antenna, a circularly polarized antenna, a micro-strip antenna, a diversity antenna, or other type of antenna suitable for transmitting and/or receiving wireless communication signals, blocks, frames, transmission streams, packets, messages and/or data.

In some embodiments, source module 104 may include a processor 181, a memory 182, a storage 183, an input 184, an output 185 and/or any other suitable hardware components and/or software components. Destination module 124 may include a processor 186, a memory 187, a storage 188, an input 189, an output 190 and/or any other suitable hardware components and/or software components. In some embodiments, data 116 may be generated by processor 181 and/or stored by memory 182 and/or storage 183. Data 128 may be processed by processor 186 and/or stored by memory 187 and/or storage 188. Processors 181 and/or 186 include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), and/or any other suitable multi-purpose or specific processor or controller. Memories 181 and/or 187 include, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, and/or one other suitable memory unit. Storage 183 and/or 188 include, for example, a hard disk drive, a floppy disk drive, a Compact Disk (CD) drive, a CD-ROM drive, a DVD drive, and/or any other suitable removable or non-removable storage units. Inputs 184 and/or 189 include, for example, a keyboard, a keypad, a mouse, a touch-pad, a track-ball, a stylus, a microphone, and/or any other suitable pointing device or input device. Outputs 185 and/or 190 include, for example, a monitor, a screen, a Cathode Ray Tube (CRT) display unit, a Liquid Crystal Display (LCD) display unit, a plasma display unit, one or more audio speakers, and/or any other suitable output device.

In some demonstrative embodiments, source module 104 and wireless source module 106 may be implemented as part of a source device 102, e.g., such that source module 104 and wireless source module 106 are enclosed in a common housing, packaging, or the like. In other embodiments, source module 104 and wireless source module 106 may be implemented as separate devices.

In some demonstrative embodiments, destination module 124 and wireless destination module 122 may be implemented as part of a destination device 120, e.g., such that destination module 124 and wireless destination module 122 are enclosed in a common housing, packaging, or the like. In other embodiments, destination module 124 and wireless destination module 122 may be implemented as separate devices.

In some demonstrative embodiments, wireless source module 106 may include or may be implemented as a wireless communication card, which may be attached to source module 104 externally or internally.

In some demonstrative embodiments, wireless destination module 122 may include or may be implemented as a wireless communication card, which may be attached to destination module 124 externally or internally.

In some embodiments, data 116 may include video data in any suitable video format, e.g., as described herein. In other embodiments, data 116 may include any other suitable data and/or information.

In some demonstrative embodiments, downlink transmission 121 may include, for example, a video transmission, e.g., a HDTV video transmission or any other suitable video transmission.

In some non-limiting demonstrative embodiments, wireless source module 106 may generate downlink transmission 121 including at least one coarse constellation symbol and at least one fine constellation symbol representing data 116, for example, by applying a de-correlating transformation, e.g., a Discrete-Cosine-Transformation (DCT), to data 116, e.g., as described in U.S. patent application Ser. No. 11/551,641, entitled “Apparatus and method for uncompressed, wireless transmission of video”, filed Oct. 20, 2006, and published May 3, 2007, as US Patent Application Publication US 2007-0098063 (“the '641 Application”), the entire disclosure of which is incorporated herein by reference. Wireless destination module 122 implement the wireless-video receiver described in the '641 Application. In other embodiments, wireless source module 106 may implement any other suitable transmission method and/or configuration to generate transmission 121 and/or destination module 122 may implement any suitable reception method and/or configuration to receive transmission 121.

In some demonstrative embodiments, source module 104 and/or source device 102 may include any suitable video device or module, for example, a portable video source, a non-portable video source, a Set-Top-Box (STB), a DVD, a digital-video-recorder, a game console, a PC, a portable computer, a Personal-Digital-Assistant (PDA), a Video Cassette Recorder (VCR) a video camera, a cellular phone, a video player, a portable-video-player, a portable DVD player, an MP-4 player, a video dongle, a cellular phone, and the like. Destination module 124 and/or destination device 120 may include any suitable video display or receiver to handle video data 128. For example, destination module 124 and/or destination device 120 may include a display or screen, e.g., a flat screen display, a Liquid Crystal Display (LCD), a plasma display, a back projection television, a television, a projector, a monitor, an audio/video receiver, a video dongle, and the like.

In some embodiments, BB module 166 and/or BB module 164 may include, for example, a digital BB integrated circuit (“chip”). RF module 167 and/or RF module 165 may include, for example, an analog RF chip.

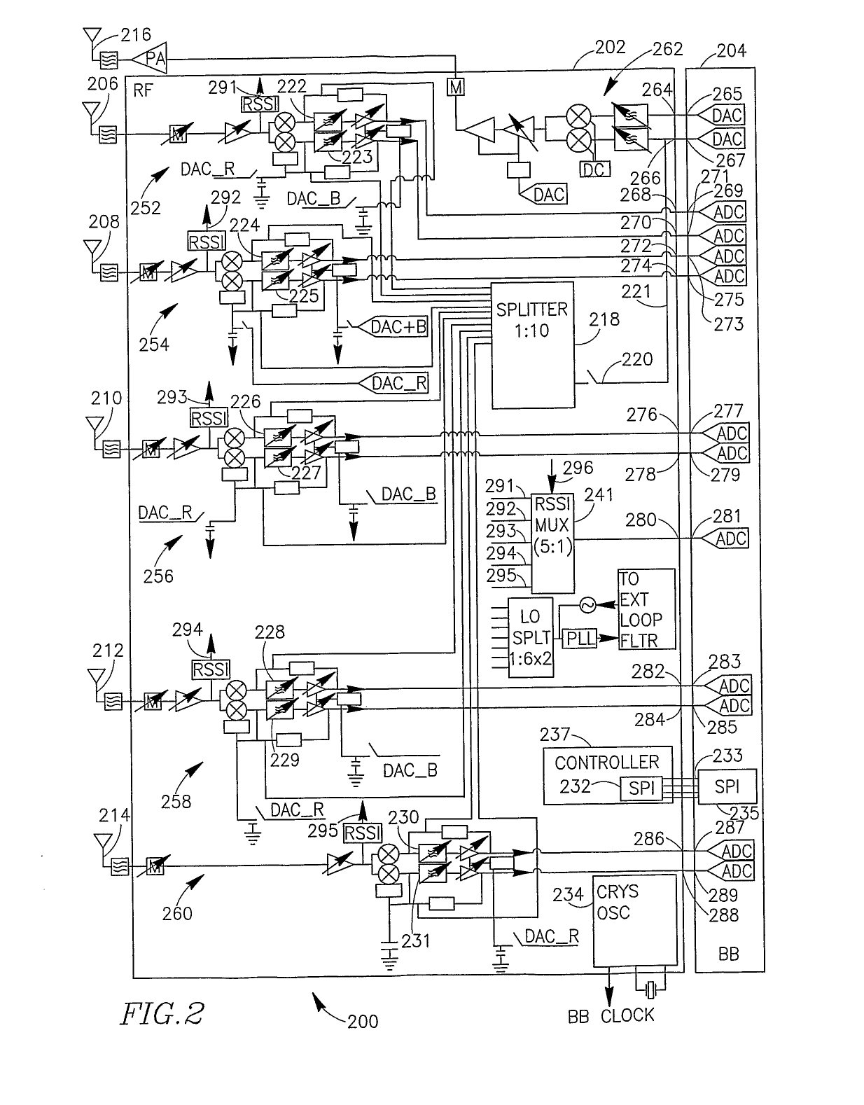

In some demonstrative embodiments, wireless destination module 122 may implement a destination BB-RF interface scheme to interface between RF module 165 and BB module 164, e.g., as described below with reference to FIG. 2.

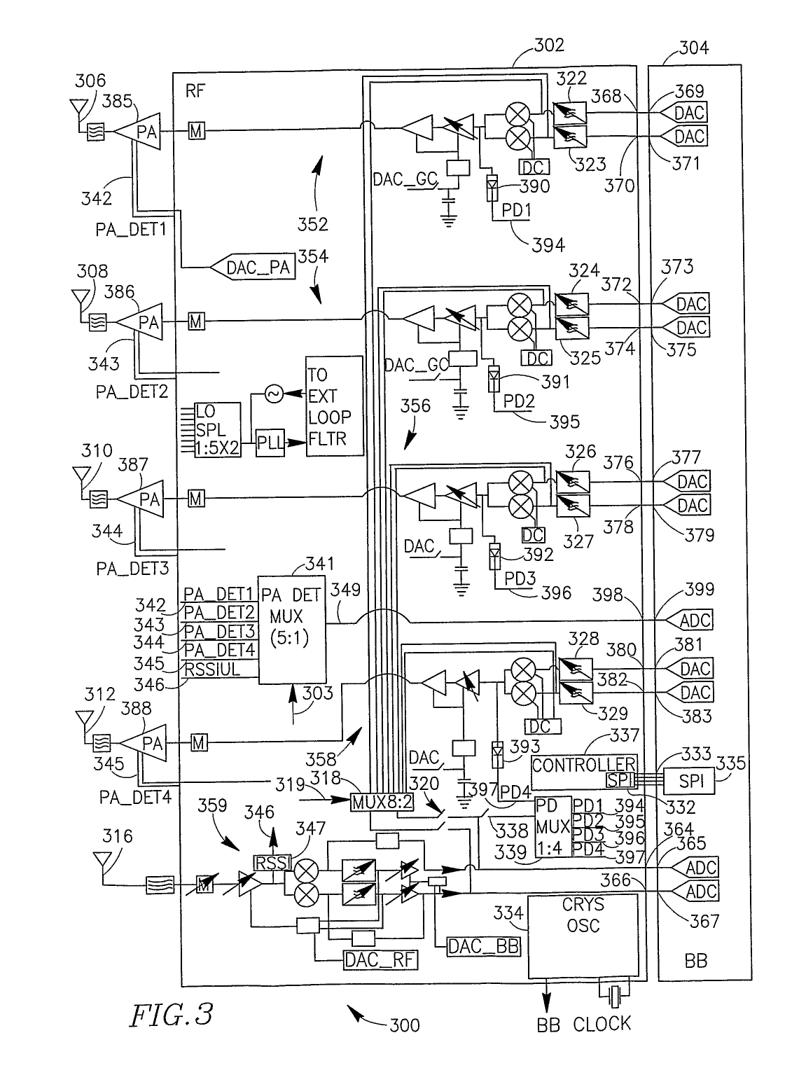

In some demonstrative embodiments, wireless source module 106 may implement a source BB-RF interface scheme to interface between RF module 167 and BB module 166, e.g., as described below with reference to FIG. 3.

In some demonstrative embodiments, BB module 166 and/or BB module 164 may be capable of interfacing with RF modules 167 and/or 165, respectively, for example, to perform one or more predefined operations or procedures to one or more elements of RF modules 167 and/or 165, respectively. The predefined operations may include, for example, control, calibration and/or re-configuration operations, e.g., as described herein.

In some embodiments, the predefined operations may include one or more of the following operations, e.g., as described in detail below:
1. Transmitter in-phase-and-quadrature-phase (IQ) imbalance and/or Local Oscillator (LO) leakage calibration.
2. Transmitter and/or receiver BB filter calibration.
3. Transmitter and/or receiver crystal oscillator frequency calibration.
4. Transmitter output power calibration.
5. Receiver Received-Signal-Strength-Indication (RSSI) for Automatic Gain Control (AGC) calibration.

In some embodiments, BB module 164 and/or RF module 165 may be capable of performing a filter calibration operation to calibrate one or more Rx filters of a plurality of Rx paths of downlink receiver 130. For example, BB module 164 may provide RF module 165 with signals 174 including a calibration signal; and RF module 165 may provide to BB module 164 signals 173 including a plurality of filtered calibration signals resulting from the filtering of the calibration signal by the Rx filters of the plurality of Rx paths, e.g., as described below with reference to FIG. 2. BB module 164 may instruct RF module 165 to calibrate one or more of the Rx filters based on the filtered calibration signals.

In some embodiments, BB module 164 may provide RF module 165 with a RSSI control signal; and RF module 165 may provide BB module 164 with at least one RSSI signal corresponding to wireless signals received via at least one of receive antennas 127, respectively, e.g., as described below with reference to FIG. 2. Based on the combined RSSI signal, BB module 164 may perform AGC calibration and/or calibration of Low-Noise-Amplifier (LNA) gain level of one or more of the Rx paths.

In some embodiments, RF module 165 may include an oscillator, e.g., oscillator 234 as described below with reference to FIG. 2. BB module 164 may provide RF module 165 with an oscillator calibration signal and, responsive to the oscillator calibration signal, RF module 165 may calibrate an oscillation frequency of the oscillator, e.g., as described below with reference to FIG. 2.

In some embodiments BB module 166 and/or RF module 167 may be capable of performing a filter calibration operation to calibrate one or more Tx filters of Tx paths of downlink transmitter 112. For example, BB module 166 may provide RF module 167 with signals 171 including at least one filter calibration signal corresponding to at least one of the Tx paths in transmitter 112; and RF module 167 may provide to BB module 166 signals 172 including at least one filtered calibration signal corresponding to the at least one filter calibration signal, e.g., as described below with reference to FIG. 3. BB module 166 may instruct RF module 167 to calibrate one or more of the Tx filters based on the at least one filtered calibration signal.

In some embodiments, RF module 167 may include an oscillator, e.g., oscillator 334 as) described below with reference to FIG. 3. BB module 166 may provide RF module 167 with an oscillator calibration signal and, responsive to the oscillator calibration signal, RF module 167 may calibrate an oscillation frequency of the oscillator, e.g., as described below with reference to FIG. 3.

In some embodiments, BB module 166 may provide RF module 167 with a predefined control signal and signals 171 including at least one predefined calibration signal; and RF module 167 may provide to BB module 166 signals 172 including at least one power-detector signal corresponding to the predefined calibration signal, e.g., as described below with reference to FIG. 3. BB module may calibrate an IQ imbalance and/or a LO leakage of one or more of the Tx paths based on the at least one power-detector signal, e.g., as described below.

In some embodiments, BB module 166 may provide RF module 167 with a predefined control signal identifying a Tx path corresponding to a selected one of transmit antennas 111; and, in response to the control signal, RF module 167 may output to BB module 166 a power-amplifier-detect signal corresponding to a power-amplification along the selected transmit path, e.g., as described below with reference to FIG. 3. BB module 166 may include any suitable power-calibration mechanism to perform an output power calibration of the selected Tx path based on the power-amplifier-detect signal, for example, as part of a suitable Transmit-Power-Control (TPC) mechanism, to overcome gain variance of the selected Tx path, and/or as part of any other suitable operation or process.

In some embodiments, BB module 166 may provide RF module 167 with a RSSI control signal; and RF module 167 may provide BB module 166 with a RSSI signal corresponding to wireless signals received via receive antennas 110, e.g., as described below with reference to FIG. 3. Based on the RSSI signal, BB module 166 may perform AGC calibration and/or calibration of Low-Noise-Amplifier (LNA) gain level of an Rx path of uplink receiver 114.

Reference is now made to FIG. 2, which schematically illustrates a destination RF-BB interface scheme 200 in accordance with some demonstrative embodiments. In one embodiment, interface scheme 200 may be implemented by wireless destination module 122 (FIG. 1) to interface between RF module 165 (FIG. 1) and BB module 164 (FIG. 1).

Interface scheme 200 may include a destination RF module 202 interfaced with a destination BB module 204.

In some embodiments, RF module 202 may include at least one transmit antenna and a plurality of receive antennas. For example, as shown in FIG. 2, RF module 202 may include five Rx antennas 206, 208, 210, 212 and 214 to receive a downlink MIMO transmission of five respective Rx paths 252, 254, 256, 258 and 260; and a Tx antenna 216 to transmit an uplink transmission via an uplink Tx path 262. In one embodiment, RF module 202 and/or BB module 204 may perform the functionality of RF module 165 (FIG. 1) and/or BB module 164 (FIG. 1), respectively; Rx antennas 206, 208, 210, 212 and 214 may perform the functionality of Rx antennas 127 (FIG. 1); and/or Tx antenna 216 may perform the functionality of Tx antenna 126 (FIG. 1).

In some embodiments, RF module 202 may include at least one uplink input connectable to BB module 204 to receive from BB module 204 uplink signals to be transmitted via the at least one transmit antenna. For example, as shown in FIG. 2, RF module 202 may include a first uplink input 264 connectable to a first uplink output 265 of BB module 204 to receive a first signal to be transmitted via path 262, and a second uplink input 266 connectable to a second uplink output 267 of BB module 204 to receive a second signal to be transmitted via path 262.

In some embodiments RF module 202 may include a plurality of downlink outputs connectable to BB module 204 to provide BB module 204 with downlink signals corresponding to wireless signals received via the plurality of receive antennas. In one embodiment, the plurality of downlink outputs include a plurality of sets of at least two downlink outputs, wherein each set of downlink outputs is to provide BB module 204 with downlink signals corresponding to wireless signals received via a respective one of the plurality of receive antennas. For example, as shown in FIG. 2, RF module 202 may include five sets of two downlink outputs corresponding to the five Rx antennas 206, 208, 210, 212 and 214, respectively. For example, as shown in FIG. 2, RF module 202 may include a set of downlink outputs 268 and 270 connectable to a set of downlink inputs 269 and 271, respectively, of BB module 204 to provide BB module 204 with downlink signals received via Rx path 252; a set of downlink outputs 272 and 274 connectable to a set of downlink inputs 273 and 275, respectively, of BB module 204 to provide BB module 204 with downlink signals received via Rx path 254; a set of downlink outputs 276 and 278 connectable to a set of downlink inputs 277 and 279, respectively, of BB module 204 to provide BB module 204 with downlink signals received via Rx path 256; a set of downlink outputs 282 and 284 connectable to a set of downlink inputs 283 and 285, respectively, of BB module 204 to provide BB module 204 with downlink signals received via Rx path 258; and a set of downlink outputs 286 and 288 connectable to a set of downlink inputs 287 and 289, respectively, of BB module 204 to provide BB module 204 with downlink signals received via Rx path 260.

In some embodiments, RF module 202 may include a control interface 233 connectable to BB module 204 to receive one or more control signals from BB module 204, e.g., as described herein. In one embodiment, control interface 233 may include a synchronous serial data interface to communicate with BB module 204 according to a suitable synchronous serial data communication scheme, e.g., as described below. In one embodiment, interface 233 may include, for example, three-wire serial bus, for example, a Serial-Peripheral-Interface (SPI) bus, e.g., including a serial clock line, a data input line and a data output line. For example, as shown in FIG. 2, interface 233 may connect between an SPI module 232 in RF module 202 and an SPI module 235 in BB module 204. SPI module 232 may be implemented as part of a controller 237 capable of controlling one or more operations of RF module 202, e.g., as described below. In other embodiments any other suitable controller and/or control interface may be used, e.g., without utilizing the SPI modules.

In some embodiments, RF module 202 may include a plurality of Rx filters to filter the wireless signals received via the plurality of receive antennas. For example, as shown in FIG. 2, RF module 202 may include Rx filters 222 and 223 to filter signals along Rx path 252; Rx filters 224 and 225 to filter signals along Rx path 254; Rx filters 226 and 227 to filter signals along Rx path 256; Rx filters 228 and 229 to filter signals along Rx path 258; and Rx filters 230 and 231 to filter signals along Rx path 260.

In some demonstrative embodiments, interface scheme 200 may allow performing Rx filter calibration, for example, to calibrate a 3 decibel (dB) corner frequency of one or more of Rx filters 222, 223, 224, 225, 226, 227, 228, 229, 230 and 231, e.g., as described herein.

In some embodiments, BB module 204 may utilize the Rx filter calibration to correct a deviation of the corner frequency of the Rx filters from a required target. Such deviation may occur, for example, due to process and/or temperature variation. Calibration of the Rx filters may be required, for example, to attenuate out of band interference at RF module 202, e.g., when the 3 dB corner frequency increases; and/or to make sure the bins at high frequencies, e.g., around 9 MHz, will not suffer from an increase in their Signal-to-Noise-Ratio (SNRs), e.g., when the 3 dB corner frequency decreases. For example, BB module 204 may instruct controller 237 to calibrate one or more of Rx filters 222, 223, 224, 225, 226, 227, 228, 229, 230 and 231, e.g., by providing RF module 202 with a suitable instruction signal via interface 233. RF module 202 may calibrate one or more of Rx filters 222, 223, 224, 225, 226, 227, 228, 229, 230 and 231 based on the instruction signal. In other embodiments, the Rx filter calibration may be utilized by RF module 202 and/or BB module 204 as part of any other suitable operation.

In some embodiments, BB module 204 may provide RF module 202 with a filter-calibration control signal, e.g., via interface 233. BB module 204 may also provide RF module 202 with a filter calibration signal via uplink input 266. Responsive to the filter-calibration control signal, RF module 204 may output via one or more of the plurality of downlink outputs, e.g., via outputs 268, 270, 272, 274, 276, 278, 282, 284, 286 and/or 288, one or more respective filtered calibration signals corresponding to the received filter calibration signal, e.g., as described below.

In some embodiments, RF module 202 may include a splitter 218 having a plurality of outputs connected to inputs of the plurality of Rx filters, respectively. For example, as shown in FIG. 2, splitter 218 may include ten outputs connected to the inputs of the ten Rx filters 222, 223, 224, 225, 226, 227, 228, 229, 230 and 231, respectively.

In some embodiments, RF module 202 may include a switch having a closed mode, in which uplink input 266 is connected to an input of splitter 218, and an open mode, in which uplink input 266 is disconnected from the input of splitter 218.

In some embodiments, controller 237 may receive the filter-calibration control signal via interface 233. Responsive to the filter calibration control signal, controller 237 may cause switch 220 to switch to the closed mode, thereby to transfer the filter calibration signal to the inputs of Rx filters 222, 223, 224, 225, 226, 227, 228, 229, 230 and 231. The calibration signal may be filtered by Rx filters 222, 223, 224, 225, 226, 227, 228, 229, 230 and 231, and the resulting filtered calibration signals may be provided back to BB module 204 via outputs 268, 270, 272, 274, 276, 278, 282, 284, 286 and 288, respectively. BB module 204 may determine a required calibration of one or more of the Rx filters 222, 223, 224, 225, 226, 227, 228, 229, 230 and 231, e.g., based on the received filtered calibration signals. BB module 204 may instruct controller 237, e.g., by transmitting suitable instruction signals via interface 233, to calibrate one or more of the Rx filters according to the required calibration.

In some demonstrative embodiments, RF module 202 may include any suitable oscillator 234.

In some embodiments, interface 200 scheme may allow calibrating an oscillation frequency of oscillator 234. For example, it may be desired to calibrate the oscillation frequency of oscillator 234 due to impairments of oscillator 234, e.g., aging, frequency stability and/or temperature stability, and the like.

In some demonstrative embodiments, BB module 204 may instruct controller 237 to calibrate the oscillation frequency oscillator 234 by providing controller 237 with a predefined oscillator calibration signal, e.g., via interface 233. Responsive to the oscillator calibration signal, controller 237 may calibrate the oscillation frequency of oscillator 234. The oscillation frequency of oscillator 234 may be calibrated, for example, by changing load capacitances of oscillator 234, and/or using any other suitable oscillator calibration method.

In some demonstrative embodiments, interface scheme 200 may allow calibrating a Low-Noise-Amplifier (LNA) gain level of one or more of Rx paths 252, 254, 256, 258 and 260. In one example, BB module 204 may adjust the LNA gain level of an Rx path based on a RSSI level of the Rx path, which may be based, for example, on the detection of a signal along the Rx path, e.g., as described below.

In some embodiments, RF module 202 may include a RSSI output 280 connectable to BB module 204, e.g., via an RSSI input 281. BB module 204 may provide RF module 202 with a RSSI control signal, e.g., via interface 233. Responsive to the RSSI control signal, RF module 202 may provide BB module 204, e.g., via output 280, with at least one RSSI signal corresponding to wireless signals received via at least one of the plurality of receive antennas, respectively. For example, as shown in FIG. 2, RF module 202 may include an RSSI multiplexer 241 having five inputs to receive five RSSI signals 291, 292, 293, 294 and 295, respectively, from the five Rx paths 252, 254, 256, 258 and 260, respectively. Multiplexer 241 may output to RSSI output 280 a selected RSSI signal of signals 291, 292, 293, 294 and 295, e.g., based on a selection signal 296 received from controller 237. For example, controller 237 may generate selection signal 296 to control multiplexer 241 to select the outputted RSSI signal of a selected Rx path indicated by the received RSSI control signal. BB module 204 may include any suitable LNA gain level calibration mechanism to calibrate the LNA gain level of the selected Rx path based on the outputted RSSI signal, e.g., such that an Error Vector Magnitude (EVM) characteristic is minimized.

Reference is now made to FIG. 3, which schematically illustrates a source RF-BB interface scheme 300 in accordance with some demonstrative embodiments. In one embodiment, interface scheme 300 may be implemented by wireless source module 106 (FIG. 1) to interface between RF module 167 (FIG. 1) and BB module 166 (FIG. 1).

Interface scheme 300 may include a source RF module 302 interfaced with a source BB module 304.

In some embodiments, RF module 302 may include at least one receive antenna and a plurality of transmit antennas. For example, as shown in FIG. 3, RF module 302 may include four Tx antennas 306, 308, 310 and 312 to transmit an uplink MIMO transmission of four respective Tx paths 352, 354, 356 and 358; and an Rx antenna 316 to receive an uplink transmission via an uplink Rx path 359. In one embodiment, RF module 302 and/or BB module 304 may perform the functionality of RF module 167 (FIG. 1) and/or BB module 166 (FIG. 1), respectively; Tx antennas 306, 308, 310 and 312 may perform the functionality of Tx antennas 111 (FIG. 1); and/or Rx antenna 316 may perform the functionality of Rx antenna 110 (FIG. 1).

In some embodiments, RF module 302 may include at least one uplink output connectable to BB module 304 to provide to BB module 304 uplink signals received via the at least one receive antenna. For example, as shown in FIG. 3, RF module 302 may include a first uplink output 364 connectable to a first uplink input 365 of BB module 304 to provide to BB module 304 a first signal received via path 359, and a second uplink output 366 connectable to a second uplink input 367 of BB module 304 to provide to BB module 304 a second signal received via path 359.

In some embodiments RF module 302 may include a plurality of downlink inputs connectable to BB module 304 to receive from BB module 304 downlink signals to be transmitted via the plurality of Tx paths. In one embodiment, the plurality of downlink inputs include a plurality of sets of at least two downlink inputs, wherein each set of downlink inputs is to receive from BB module 304 downlink signals to be transmitted via a respective one of the plurality of Tx antennas. For example, as shown in FIG. 3, RF module 302 may include four sets of two downlink inputs corresponding to the four Tx antennas 306, 308, 310 and 312, respectively. For example, as shown in FIG. 3, RF module 302 may include a set of downlink inputs 368 and 370 connectable to a set of downlink outputs 369 and 371, respectively, of BB module 304 to receive from BB module 304 downlink signals to be transmitted via Tx path 352; a set of downlink inputs 372 and 374 connectable to a set of downlink outputs 373 and 375, respectively, of BB module 304 to receive from BB module 304 downlink signals to be transmitted via Tx path 354; a set of downlink inputs 376 and 378 connectable to a set of downlink outputs 377 and 379, respectively, of BB module 304 to receive from BB module 304 downlink signals to be transmitted via Tx path 356; and a set of downlink inputs 380 and 382 connectable to a set of downlink outputs 381 and 383, respectively, of BB module 304 to receive from BB module 304 downlink signals to be transmitted via Tx path 358.

In some embodiments, RF module 302 may include a control interface 333 connectable to BB module 304 to receive one or more control signals from BB module 304, e.g., as described herein. In one embodiment, control interface 333 may include a synchronous serial data interface to communicate with BB module 304 according to a suitable synchronous serial data communication scheme, e.g., as described below. In one embodiment, interface 333 may include, for example, three-wire serial bus, for example, a SPI bus, e.g., including a serial clock line, a data input line and a data output line. For example, as shown in FIG. 3, interface 333 may connect between an SPI module 332 in RF module 302 and an SPI module 335 in BB module 304. SPI module 332 may be implemented as part of a controller 337 capable of controlling one or more operations of RF module 302, e.g., as described below. In other embodiments any other suitable controller and/or control interface may be used, e.g., without utilizing the SPI modules.

In some embodiments, RF module 302 may include a plurality of Tx filters to filter the wireless signals received via the plurality of downlink inputs. For example, as shown in FIG. 3, RF module 302 may include Tx filters 322 and 323 to filter signals received via inputs 368 and 370, respectively, of Tx path 352; Tx filters 324 and 325 to filter signals received via inputs 372 and 374, respectively, of Tx path 354; Tx filters 326 and 327 to filter signals received via inputs 376 and 378, respectively, of Tx path 356; and Tx filters 328 and 329 to filter signals received via inputs 380 and 382, respectively, of Tx path 358.

In some demonstrative embodiments, interface scheme 300 may allow performing Tx filter calibration, for example, to calibrate a 3 dB corner frequency of one or more of Tx filters 322, 323, 324, 325, 326, 327, 328 and 329, e.g., as described herein.

In some embodiments, BB module 304 and/or RF module 302 may utilize the Tx filter calibration to correct a deviation of the corner frequency of the Tx filters from a required target. Such deviation may occur, for example, due to process and/or temperature variation. Calibration of the Tx filters may be required, for example, to support Adjacent Channel Power Ratio (ACPR) limits by regulation at the RF module 304, e.g., when the 3 dB corner frequency increases, and/or to ensure that frequency bins of high frequencies, e.g., around 9 MHz, will not suffer a decrease in their SNR, e.g., when the 3 dB corner frequency decreases. For example, BB module 304 may instruct controller 337 to calibrate one or more of Tx filters 322, 323, 324, 325, 326, 327, 328 and 329, e.g., by providing RF module 302 with a suitable instruction signal via interface 333. RF module 302 may calibrate one or more of Tx filters 322, 323, 324, 325, 326, 327, 328 and 329 based on the instruction signal. In other embodiments, the Tx filter calibration may be utilized by RF module 302 and/or BB module 304 as part of any other suitable operation.

In some embodiments, BB module 304 may provide RF module 302 with a filter-calibration control signal, e.g., via interface 233. BB module 304 may also provide RF module 302 with at least one filter calibration signal via at least one of the plurality of downlink inputs 368, 370, 372, 374, 376, 378, 380 and/or 382, respectively. Responsive to the filter-calibration control signal, RF module 304 may output via at least one of uplink outputs 364 and 366 at least one respective filtered calibration signal corresponding to the at least one filter calibration signal, respectively. In one embodiment, RF module 304 may output via uplink output 364 a first filtered calibration signal, e.g., corresponding to a first Tx filter of Tx filters 322, 323, 324, 325, 326, 327, 328 and 329; and via uplink output 366 a second filtered calibration signal corresponding to another Tx filter of Tx filters 322, 323, 324, 325, 326, 327, 328 and 329. In other embodiments, RF module 304 may output via uplink outputs 364 and/or 366 any other suitable combination of the filtered calibration signals.

In some embodiments, RF module 302 may include a multiplexer having a plurality of inputs connected to outputs of the plurality of Tx filters; and having at least one output to selectively output, based on a selection signal 319, at least one filtered calibration signal received via at least one selected input of the plurality of inputs. For example, as shown in FIG. 3, RF module 302 may include an 8:2 multiplexer 318 having eight inputs connected to the outputs of the eight Tx filters 322, 323, 324, 325, 326, 327, 328 and 328, respectively; and two outputs to output two respective filtered calibration signals, each including, for example, a filtered calibration signal received via a different one of the inputs of multiplexer 318.

In some embodiments, RF module 302 may include at least one switch having a closed mode, in which the at least one output of the multiplexer is connected to the at least one uplink output, respectively, and an open mode, in which the at least one output of the multiplexer is disconnected from the at least one uplink output, respectively. For example, as shown in FIG. 3, RF module 302 may include a set of two switches 320 having a closed mode, in which the two outputs of multiplexer 318 are connected to uplink outputs 364 and 366, respectively, and an open mode, in which the two outputs of multiplexer 318 are disconnected from uplink outputs 364 and 366, respectively.

In some embodiments, controller 337 may receive the filter-calibration control signal via interface 333. The filter calibration signals provided via downlink inputs 368, 370, 372, 374, 376, 378, 380 and/or 382 may be filtered by Tx filters 322, 323, 324, 325, 326, 327, 328 and/or 329, respectively. Responsive to the filter calibration control signal, controller 337 may generate the selection signal 319 to cause multiplexer 318 to output two selected filtered calibration signal of two selected Tx filters indicated by the received filter calibration control signal. Controller 337 may cause switches 320 to switch to the closed mode, thereby to transfer the two filtered calibration signals from the two outputs of multiplexer 318 to uplink outputs 364 and 366, respectively. BB module 304 may determine a required calibration of one or more of the Tx filters 322, 323, 324, 325, 326, 327, 328 and 329, e.g., based on the filtered calibration signals received via uplink outputs 364 and 366. BB module 304 may instruct controller 337, e.g., by transmitting suitable instruction signals via interface 333, to calibrate one or more of the Tx filters according to the required calibration.

In some demonstrative embodiments, RF module 302 may include any suitable oscillator 334.

In some embodiments, interface 300 scheme may allow calibrating an oscillation frequency of oscillator 334. For example, it may be desired to calibrate the oscillation frequency of oscillator 334 due to impairments of oscillator 334, e.g., aging, frequency stability and/or temperature stability, and the like.

In some demonstrative embodiments, BB module 304 may instruct controller 337 to calibrate the oscillation frequency oscillator 334 by providing controller 337 with a predefined oscillator calibration signal, e.g., via interface 333. Responsive to the oscillator calibration signal, controller 337 may calibrate the oscillation frequency of oscillator 334. The oscillation frequency of oscillator 334 may be calibrated, for example, by changing load capacitances of oscillator 334, and/or using any other suitable oscillator calibration method.

In some embodiments, interface scheme 300 may allow calibrating an IQ imbalance and/or a LO leakage of one or more of Tx paths 352, 354, 356 and 358, e.g., as described below. The IQ imbalance calibration may be performed, for example, to reduce the imbalance between the in-phase (I) and quadrature (Q) branches of Tx paths 352, 354, 356 and/or 358. The IQ imbalance may result, for example, from a phase deviation, e.g., from an ideal 90° between I and Q local oscillator (LO) signals. Other sources for imbalance may include amplitude and delay mismatches between the I and Q ranches and/or different cutoff frequencies of filters in BB module 304. This IQ imbalance may, therefore, be assumed to be frequency dependent.

In some embodiments, RF module 302 may output via an uplink output of outputs 364 and 366 at least one power-detector (PD) signal, responsive to at least one predefined calibration signal received via at least one of the plurality of downlink inputs. For example, RF module 302 may output the PD signal to BB module 304, in response to receiving from BB module 304 a predefined control signal, e.g., via interface 333, and at least one predefined calibration signal, e.g., via at least one of downlink inputs 368, 370, 372, 374, 376, 378, 380 and 382, respectively.

In some embodiments, as shown in FIG. 3, RF module 302 may include a plurality of power detectors 390, 391, 392, 393 and 394 located along Tx paths 352, 354, 356 and 358, respectively. Power detectors 390, 391, 392, 393 and 394 may generate a plurality of power-detection signals 394, 395, 396 and 397, respectively, in response to a plurality of calibration signals received via downlink inputs 368, 370, 372, 374, 376, 378, 380 and 382, respectively. RF module 302 may include a PD multiplexer, e.g., a 4:1 multiplexer 339, having a plurality of inputs, e.g., four inputs, connected to the outputs of the plurality of power detectors, e.g., the outputs of power detectors 390, 391, 392, 393 and 394, respectively. Multiplexer 339 may selectively output, based on a selection signal 301, a selected PD signal of PD signals 394, 395, 396 and 397. RF module 302 may also include a switch 338 having a closed mode, in which the output of multiplexer 339 is connected to uplink output 364, and an open mode, in which the output of multiplexer 339 is disconnected from uplink output 364. BB module 304 may provide the PD control signal to controller 337, e.g., via interface 333. Responsive to the PD control signal, controller 337 may generate selection signal 301 to cause multiplexer 339 to output the selected PD signal of a selected power detector indicated by the received filter calibration control signal. Controller 337 may cause may cause switch 338 to switch to the closed mode, thereby providing the selected PD signal from multiplexer 339 back to BB module 304 via uplink output 364. BB module 304 may determine a required IQ calibration and/or a required LO leakage calibration, e.g., based on the combined PD signal; and may calibrate Tx paths 352, 354, 356 and/or 358 accordingly.

In some demonstrative embodiments, interface scheme 300 may allow BB module 304 to perform an output power calibration of one or more of Tx paths 352, 354, 356 and 358, for example, as part of a suitable TPC mechanism, to overcome gain variance of the Tx paths, and/or as part of any other suitable operation or process.

In some embodiments, RF module 302 may include a power-amplifier output 398 connectable to BB module 304, e.g., via a power-amplifier input 399. RF module may be capable of receiving form BB module 304, e.g., via interface 333, a predefined control signal identifying a selected Tx path of Tx paths 352, 354, 356 and 358. In response to the control signal, RF module 302 may output via power-amplifier output 398 a power-amplifier-detect signal) corresponding to a power-amplification along the selected Tx path.

In some embodiments, as shown in FIG. 3, RF module 302 may include a plurality of power amplifiers 385, 386, 387 and 388 located along the plurality of Tx paths 352, 354, 356 and 358, respectively. RF module 302 may also include a multiplexer 341 having an output 349 connected to power-amplifier output 398 and a plurality of inputs to receive a plurality of power-amplifier-detect signals 342, 343, 344 and 345 from power amplifiers 385, 386, 387 and 388, respectively. Controller 337 may receive the predefined control signal identifying the selected Tx path, e.g., via interface 333. Responsive to the predefined control signal, controller 337 may generate a selection signal 303 to cause multiplexer 341 to output the power-amplifier-detect signal of the selected TX path. BB module 304 may include any suitable power-calibration mechanism to perform an output power calibration of the selected Tx path based on the power-amplifier-detect signal. BB module 304 may perform the output power calibration, for example, as part of a suitable TPC mechanism, to overcome gain variance of the selected Tx path, and/or as part of any other suitable operation or process.

In some embodiments, RF module 302 may include an RSSI module 347 to generate an RSSI signal 346 corresponding to wireless signals received via Rx antenna 316. Multiplexer 341 may also include a RSSI input to receive RSSI signal 346. Controller 337 may receive a RSSI control signal from BB module 304, e.g., via interface 333. Responsive to the RSSI control signal, controller 337 may generate selection signal 303 to cause multiplexer 341 to output RSSI signal 346. BB module 304 may include any suitable LNA gain level calibration mechanism to calibrate the LNA gain level of the Rx path based on the RSSI signal 346, e.g., such that an EVM characteristic is minimized.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk—read only memory (CD-ROM), compact disk—read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of embodiments of the invention have been illustrated and described herein, many modifications, substitutions, changes, and equivalents may occur to those skilled in the art. It is, therefore, to be understood that the appended claims are intended to cover all such modifications and changes.

What is claimed is:

1. A wireless communication device including a radio-frequency (RF) module connectable to a base-band (BB) module, the RF module including:
at least one transmit antenna;
a plurality of receive antennas;
at least one uplink input connectable to the BB module to receive from the BB module uplink signals to be transmitted via the at least one transmit antenna;
a plurality of downlink outputs connectable to the BB module to provide the BB module with downlink signals corresponding to wireless signals received via the plurality of receive antennas; and
a control interface connectable to the BB module to receive from the BB module a filter-calibration control signal,
wherein, responsive to the filter-calibration control signal, the RF module is to output via one or more of the plurality of downlink outputs one or more respective filtered calibration signals corresponding to a filter calibration signal received via the uplink input.

2. The wireless communication device of claim 1, wherein the RF module includes:
a plurality of receive filters to filter the wireless signals received via the plurality of receive antennas;
a splitter having a plurality of outputs connected to inputs of the plurality of receive filters, respectively;
a switch having a closed mode, in which the uplink input is connected to an input of the splitter, and an open mode, in which the uplink input is disconnected from the input of the splitter; and
a controller to receive the control signal via the control interface and, responsive to the control signal, to cause the switch to switch to the closed mode.

3. The wireless communication device of claim 2, wherein the controller is to receive from the BB module a calibration instruction via the control interface, and to calibrate one or more of the receive filters based on the calibration instruction.

4. The wireless communication device of claim 1, wherein the RF module includes:
an oscillator; and
a controller to receive from the BB module an oscillator calibration signal via the control interface and, responsive to the oscillator calibration signal, to calibrate an oscillation frequency of the oscillator.

5. The wireless communication device of claim 1, wherein the RF module includes:
a received-signal-strength-indicator (RSSI) output connectable to the BB module,
wherein, responsive to a RSSI control signal received via the control interface, the RF module is to output via the RSSI output at least one RSSI signal corresponding to wireless signals received via at least one of the plurality of receive antennas, respectively.

6. The wireless communication device of claim 5, wherein the RSSI control signal indicates a selected receive antenna of the plurality of receive antennas, and wherein the outputted RSSI signal corresponds to wireless signals received via the selected receive antenna.

7. The wireless communication device of claim 1, wherein the plurality of downlink outputs include a plurality of sets of at least two downlink outputs, wherein each set of downlink outputs is to provide the BB module with downlink signals corresponding to wireless signals received via a respective one of the plurality of receive antennas.

8. The wireless communication device of claim 1, wherein the filter calibration signal and the plurality of filtered calibration signals include analog signals, and wherein the filter calibration control signal includes a digital signal.

9. The wireless communication device of claim 1, wherein the control interface includes a serial-peripheral-interface bus.

10. The wireless communication device of claim 1, wherein, responsive to the filter-calibration control signal, the RF module is to output via the plurality of downlink outputs a respective plurality of filtered calibration signals corresponding to the filter calibration signal.

11. A wireless communication device including a radio-frequency (RF) module connectable to a base-band (BB) module, the RF module including:
at least one receive antenna;
a plurality of transmit antennas;
a plurality of downlink inputs connectable to the BB module to receive from the BB module downlink signals to be transmitted via the plurality of transmit antennas;
at least one uplink output connectable to the BB module to provide the BB module with uplink signals corresponding to wireless signals received via the at least one receive antenna; and
a control interface connectable to the BB module to receive from the BB module a filter-calibration control signal,
wherein, responsive to the filter-calibration control signal and to at least one filter calibration signal received via at least one of the plurality of downlink inputs, respectively, the RF module is to output via the uplink output at least one filtered calibration signal corresponding to the at least one filter calibration signal, respectively.

12. The wireless communication device of claim 11, wherein the RF module includes:
a plurality of transmit filters to filter the wireless signals received via the plurality of downlink inputs;
a multiplexer having a plurality of inputs connected to outputs of the plurality of transmit filters, respectively, and at least one output to selectively output, based on a selection signal, at least one filtered calibration signal received via at least one selected input of the plurality of inputs;
at least one switch having a closed mode, in which the at least one output of the multiplexer is connected to the at least one uplink output, respectively, and an open mode, in which the at least one output of the multiplexer is disconnected from the at least one uplink output, respectively; and
a controller to receive the filter-calibration control signal via the control interface and, responsive to the filter-calibration control signal, to cause the switch to switch to the closed mode, and to provide the multiplexer with the selection signal.

13. The wireless communication device of claim 12, wherein the controller is to receive from the BB module a calibration instruction via the control interface, and to calibrate one or more of the transmit filters based on the calibration instruction.

14. The wireless communication device of claim 11, wherein the RF module includes:
an oscillator; and
a controller to receive from the BB module an oscillator calibration signal via the control interface and, responsive to the oscillator calibration signal, to calibrate an oscillation frequency of the oscillator.

15. The wireless communication device of claim 11, wherein the RF module is to receive a predefined control signal via the control interface; to receive at least one predefined calibration signal via at least one of the downlink inputs, respectively; and to output via the uplink output at least one power-detector signal corresponding to the predefined calibration signal.

16. The wireless communication device of claim 15, wherein the RF module includes:
a plurality of power detectors located along a respective plurality of transit paths of the plurality of transmit antennas, respectively, wherein the plurality of power detectors are to generate a plurality of power-detection signals, respectively, responsive to a plurality of calibration signals received via the plurality of downlink inputs, respectively;
a multiplexer having a plurality of inputs connected to outputs of the plurality of power detectors, respectively, to selectively output, based on a selection signal, a selected power detector signal received via a selected input of the plurality of inputs;
a switch having a closed mode, in which the output of the multiplexer is connected to the uplink output, and an open mode, in which the output of the multiplexer is disconnected from the uplink output; and
a controller to receive the predefined control signal via the control interface and, responsive to the predefined control signal, to cause the switch to switch to the closed mode and to provide the selection signal to the multiplexer.

17. The wireless communication device of claim 11, wherein the RF module includes a power-amplifier output connectable to the BB module,
wherein the RF module is to receive via the control interface a predefined control signal form the BB module identifying a selected transmit path corresponding to a selected one of the transmit antennas, and
wherein, in response to the control signal, the RF module is to output via the power-amplifier output a power-amplifier-detect signal corresponding to a power-amplification along the selected transmit path.

18. The wireless communication device of claim 17, wherein the RF module includes:
a plurality of power amplifiers located along the plurality of transmit paths, respectively;
a multiplexer having an output connected to the power-amplifier output and a plurality of inputs to receive a plurality of power-amplifier-detect signals from the plurality of power amplifiers, respectively; and
a controller to receive the predefined control signal via the control interface and, responsive to the predefined control signal, to cause the multiplexer to output the power-amplifier-detect signal of the selected transmit path.

19. The wireless communication device of claim 18, wherein the multiplexer includes a received-signal-strength-indicator (RSSI) input to receive a RSSI signal corresponding to the wireless signals received via the receive antenna, and
wherein responsive to a RSSI control signal received via the control interface, the controller is to cause the multiplexer to output the RSSI signal.

20. The wireless communication device of claim 11, wherein the plurality of downlink inputs include a plurality of sets of at least two downlink inputs, wherein each set of downlink inputs is to receive from the BB module downlink signals to be transmitted via a respective one of the plurality of receive antennas.

21. The wireless communication device of claim 11, wherein the filtered calibration signal and the plurality of filter calibration signals include analog signals, and wherein the filter-calibration control signal includes a digital signal.

22. The wireless communication device of claim 11, wherein the control interface includes a serial-peripheral-interface bus.
